(19) United States
(12) Patent Application Publication
(10) Pub. No.: US 2008/0200637 A1
(43) Pub. Date: Aug. 21, 2008

(54) BIODEGRADABLE RESIN SHEET

(75) Inventors: Yoshio INOUE, Yokohama-shi (JP); Hexig Alata, Yokohama-shi (JP); Taizo Aoyama, Takasago-shi (JP)

Correspondence Address: SUGHRUE MION, PLLC, 2100 PENNSYLVANIA AVENUE, N.W., SUITE 800, WASHINGTON, DC, 20037, US

(73) Assignees: TOKYO INSTITUTE OF TECHNOLOGY, Tokyo (JP); KANEKA CORPORATION, Osaka (JP)

(21) Appl. No.: 11/966,938

(22) Filed: Dec. 28, 2007

Related U.S. Application Data
(60) Provisional application No. 60/924,586, filed on May 22, 2007.

(30) Foreign Application Priority Data
Dec. 29, 2006 (JP) 2006356736

(51) Int. Cl. C08G 63/00

(52) U.S. Cl. 528/271

(57) ABSTRACT

A biodegradable sheet or film that is excellent in environmental compatibility accompanied by less time dependent alteration following manufacture of the sheet, having stable flexibility is provided, which can be degraded by a microorganism or the like, and thus can be easily disposed after use. A biodegradable resin sheet which is constituted with a biodegradable (3-HA) copolymer, wherein the rate of change of the tensile elongation with respect to the change in crystallinity (%) from day 1 to day 30 after manufacturing the sheet represented by the formula (1): {[(tensile elongation (%) after a lapse of 1 day following manufacture)−(tensile elongation (%) after a lapse of 30 days following manufacture)]/[(crystallinity (%) after a lapse of 30 days following manufacture)−(crystallinity (%) after a lapse of 1 day following manufacture)]} is equal to or less than 20, and the tensile elongation after a lapse of 60 days following manufacture of the sheet is equal to or greater than 100(%).

### BACKGROUND OF THE INVENTION

1. Field of the Invention

The present invention relates to a biodegradable resin sheet constituted with a biodegradable (3-hydroxyalkanoate) copolymer.

2. Related Art

Conventionally, most plastics have been thrown away after use due to ease in processing and use, difficulty in recycling, sanitation problems, and the like. However, as increasing amount of the plastics are used and disposed, problems associated with their disposal by landfilling or incineration have drawn attention, and they may be responsible for great burden on the global environment such as deficiency of garbage landfill site, influences on ecological system by remaining nondegradable plastics in the environment, generation of detrimental gas in combustion, global warming resulting from a large amount of combustion calorie, and the like. In recent years, biodegradable plastics have been extensively developed as a material which can solve the problems of the plastic waste. In general, biodegradable plastics are generally classified into three types of: 1) aliphatic polyesters produced by microorganisms such as polyhydroxyalkanoate (hereinafter, referred to as PHA), 2) chemically synthesized aliphatic polyesters such as polylactic acid and polycaprolactone, and 3) natural polymers such as starch and cellulose acetate. Among the chemically synthesized aliphatic polyesters, polylactic acid and polycaprolactone are problematic in heat resistance, while the natural polymers are problematic in nonthermoplasticity and inferior water resistance.

Meanwhile, PHA has excellent features such as: being excellent in degradability under aerobic and anaerobic conditions; not generating toxic gas in incineration; being a plastic derived from a microorganism using a plant material; capable of having a high molecular weight; not being responsible for increase in the amount of carbon dioxide on the earth, i.e., being carbon neutral. Particularly, the property of degradability under an anaerobic condition, and capable of having a high molecular weight are noteworthy performances. Although the PHA belongs to aliphatic polyesters, it has properties of the polymer that are significantly distinct from those of the chemically synthesized aliphatic polyesters described above.

Accordingly, PHA is constituted with a natural component, and thus the problems of the waste can be solved, leading to excellent environmental compatibility. Therefore, molded products of PHA applicable to packaging materials, materials for tableware, building materials, civil materials, agricultural materials, horticultural materials, materials for adsorption, carrier and filtration, and the like have been desired.

As a typical example of PHA, poly(3-hydroxybutyrate) (hereinafter, abbreviated as PHB) is illustrated. Also in connection with PHB, utilization for molded products such as films and fibers has been studied. However, since PHB homopolymers have a high crystallinity, it is disadvantageous in hard and brittle physical properties. In addition, although PHB exhibits a ductile behavior immediately after molding, deterioration of the physical properties due to aging thereafter is marked. Thus, molded products having flexibility with stable quality have not been obtained yet under current situation.

In order to solve such problems, there is disclosed that PHB having a number average molecular weight of equal to or greater than 500,000 is stretched at a draw ratio of no less than 2 times to improve tensile elongation property (see, Japanese Unexamined Patent Application Publication No. Hei 10-176070). However, the tensile elongation property may be improved by stretching, elongation property at a level as high as over 100(%) was not achieved, and description with respect to alteration of physical properties depending on lapse of days after producing the molded product is not found at all. Accordingly, the molded product of PHB has not been obtained with a high level of flexibility in a stable manner.

Furthermore, in an attempt to improve the physical properties of PHB, there is disclosed that a copolymer having 3-hydroxybutyrate and 3-hydroxyvalylate as a monomer unit (hereinafter, abbreviated as PHBV) is obtained (see, Japanese Unexamined Patent Application Publication No. Sho 63-269989). However, this PHBV has not also been applied to use in films which necessitate flexibility, although brittleness can be improved because crystallizability is decreased as compared with PHB.

In order to solve such problems, a film molded using a composition including a biodegradable resin polycaprolactone blended with PHBV was proposed. However, polycaprolactone has a melting point as low as about 60° C., and excessive softening occurs when the temperature is beyond 50° C. Therefore, even though polycaprolactone is blended with PHBV, it is not enough for the improvement of the brittleness, flexibility and moldability of the film, whereby thus resulting film tends to cause blocking, stickiness and the like.

Furthermore, there is also disclosed to allow time dependent alteration of physical properties of a molded article of PHBV after the manufacture to be delayed by subjecting to a heat treatment at a temperature not higher than the melting temperature of PHBV (see, Japanese Unexamined Patent Application Publication No. Hei 9-501449 (published Japanese translation of a PCT application)). According to Examples shown in this patent document, an effect of allowing for delay of the time dependent alteration of physical properties was exhibited by the heat treatment, however, tendency of deterioration of physical properties is found as a result of observation for a long period of time. Moreover, by subjecting a resin composition including a plasticizer blended with PHBV to a heat treatment, initial level of flexibility can be improved (see, Japanese Unexamined Patent Application Publication No. Hei 9-504808 (published Japanese translation of a PCT application)). However, also in this case, the physical properties are likely to be deteriorated depending on lapse of days. Additionally, problems of bleeding, stickiness and the like may be caused by using the plasticizer.

As in the foregoing, taking PHB and PHBV that belong to PHAs as examples, these resins themselves have a high crystallinity, and brittle properties. Accordingly, a biodegradable PHA film having high flexibility, and not accompanied by problems of bleeding, stickiness and the like while keeping the flexibility in a stable manner has not been found so far.

In addition, a film in which PHBH is used that is a copolymer having 3-hydroxybutyrate and 3-hydroxyhexanoate as a monomer unit has been disclosed as a member of PHAs having flexibility (see, U.S. Pat. No. 5,990,271). The document discloses to obtain a back sheet and a top sheet of disposable absorptive products using PHBH having a composition ratio of the copolymer, poly(3-hydroxybutyrate)/poly(3-hydroxyhexanoate) being 95/5. Also, with respect to PHBH, PHBH having a different composition ratio separated and extracted with a dissolving solvent was reported with respect to their mechanical properties, crystallizability and the like (see, Biomacromolecules, 2002, 3, p. 1006-1012). In this document, tensile elongation property of PHBH films having a ratio of poly(3-hydroxybutyrate)/poly(3-hydroxyhexanoate) being 98/2 to 87/13 (mol/mol) is described, and the film having a ratio of poly(3-hydroxybutyrate)/poly(3-hydroxyhexanoate) being 98/2 (mol/mol) exhibited tensile elongation (%) at a level of several %, while the film having a ratio of poly(3-hydroxybutyrate)/poly(3-hydroxyhexanoate) being 87/13 (mol/mol) exhibited tensile elongation (%) at a level of 60%. Meanwhile, in the case of PHBH having a low proportion of poly(3-hydroxyhexanoate), lowering of tensile elongation immediately after producing the film is found. However, in this document, general flexible ductility is described in connection with PHBH having a high proportion of poly(3-hydroxyhexanoate), but detailed description with respect to alteration of physical properties depending on lapse of days and the like is not found, and the initial flexibility as well as possibility of retaining the flexibility depending on lapse of days is not described at all.

Further, there is also disclosed a film with defined rate of time dependent change of tensile elongation following manufacturing the film (Japanese Unexamined Patent Application Publication No. 2006-45365). However, any description of time dependent alteration of the crystallinity, and crystal structural period is not found.

### SUMMARY OF THE INVENTION

An object of the present invention is to provide a biodegradable resin sheet which is accompanied by less time dependent alteration after manufacturing the sheet, and has stable flexibility. Moreover, still another object of the present invention is to provide a film or a sheet that is excellent in environmental compatibility, which can be used in a variety of applications of sheets and films, particularly disposable products, and is biodegradable, i.e., can be degraded by a microorganism or the like in one means for disposal, and thus can be readily disposed after use.

In order to solve the aforementioned problems, the present inventors elaborately investigated, and consequently focused attention to crystallinity of a substrate resin in a sheet manufactured from PHA, and found that a biodegradable resin sheet having stable flexibility can be obtained when the sheet exhibits a rate of change of the tensile elongation (%) with respect to the change in crystallinity (%) from day 1 to day 30 after manufacturing the sheet, hereinafter, referred to as “rate of change” being equal to or less than 20. Accordingly, the present invention was accomplished.

More specifically, the present invention relates to a sheet comprising a biodegradable (3-hydroxyalkanoate) copolymer,

wherein the rate of change of the tensile elongation with respect to the change in crystallinity (%) from day 1 to day 30 after manufacturing the sheet represented by the formula (1): {[(tensile elongation (%) after a lapse of 1 day following manufacture)−(tensile elongation (%) after a lapse of 30 days following manufacture)]/[(crystallinity (%) after a lapse of 30 days following manufacture)−(crystallinity (%) after a lapse of 1 day following manufacture)]} is equal to or less than 20, and the tensile elongation after a lapse of 60 days following manufacture of the sheet is equal to or greater than 100(%). In a more preferred embodiment, the rate of change of the tensile elongation represented by the formula (1) is equal to or less than 10. Furthermore, in a preferred embodiment, the tensile elongation after a lapse of 60 days following manufacture of the sheet is equal to or greater than 150(%). In another preferred embodiment, the crystallinity after a lapse of 30 days following manufacture of the sheet is equal to or less than 45%. In a further preferable embodiment, the distance of crystal period after a lapse of 1 day following manufacture of the sheet is equal to or greater than 6.5 nm. In a further preferable embodiment, the change of the glass transition temperature from day 1 to day 30 after manufacturing the sheet represented by the formula (2): (glass transition temperature (° C.) after a lapse of 30 days following manufacture)−(glass transition temperature (° C.) after a lapse of 1 day following manufacture) is equal to or less than 2° C. In addition, in a preferred embodiment, the aforementioned biodegradable (3-hydroxyalkanoate) copolymer is poly[(3-hydroxybutyrate)-co-(3-hydroxyhexanoate)] constituted with a (3-hydroxybutyrate) recurring unit and a (3-hydroxyhexanoate) recurring unit. In a still more preferred embodiment, the constituent ratio of the recurring units of poly[(3-hydroxybutyrate)-co-(3-hydroxyhexanoate)] falls within the range of 92/8 to 80/20 (mol/mol) as represented by (3-hydroxybutyrate) unit/(3-hydroxyhexanoate) unit.

According to the present invention, a biodegradable resin sheet which is accompanied by less time dependent alteration after manufacture, and has stable flexibility can be obtained. The biodegradable resin sheet according to the present invention can be used in a variety of sheet and film applications, particularly in disposable products. Moreover, the biodegradable resin sheet according to the present invention comprises a PHA copolymer that is excellent in biodegradability, therefore, films and sheets that are excellent in environmental compatibility can be provided, which are biodegradable, i.e., can be degraded by a microorganism or the like in one means for disposal, and thus can be readily disposed after use.

### BRIEF DESCRIPTION OF THE DRAWINGS

FIG. 1 shows a graph illustrating correlation between crystallinity (after 1 day, and 30 days) and tensile elongation (after 1 day, and 30 days) plotted on each constituting proportion of 3HH.

### DETAILED DESCRIPTION OF THE INVENTION

The biodegradable resin sheet according to the present invention comprises a biodegradable (3-hydroxyalkanoate) copolymer,

wherein the rate of change of the tensile elongation with respect to the change in crystallinity (%) from day 1 to day 30 after manufacturing the sheet represented by the formula (1): {[(tensile elongation (%) after a lapse of 1 day following manufacture)−(tensile elongation (%) after a lapse of 30 days following manufacture)]/[(crystallinity (%) after a lapse of 30 days following manufacture)−(crystallinity (%) after a lapse of 1 day following manufacture)]} is equal to or less than 20, and the tensile elongation after a lapse of 60 days following manufacture of the sheet is equal to or greater than 100(%).

As the biodegradable polymer in the present invention, a biodegradable poly(3-hydroxyalkanoate) copolymer having two or more kinds of recurring units represented by [—O—CHR—CH₂—CO—] (wherein, R represents an alkyl group represented by CₙH₂ₙ₊₁; and n is an integer of 1 to 15) may be used in light of: excellent degradability under anaerobic conditions; moisture resistance; possibility of increase in the molecular weight; and the like.

Typical examples of the biodegradable poly(3-hydroxyalkanoate) include e.g., poly[(3-hydroxybutyrate)-co-(3-hydroxyvalylate)], poly[(3-hydroxybutyrate)-co-(3-hydroxyhexanoate)], poly[(3-hydroxybutyrate)-co-(3-hydroxyoctanoate)], poly[(3-hydroxybutyrate)-co-(3-hydroxydecanoate)], and the like. Among these, poly[(3-hydroxybutyrate)-co-(3-hydroxyhexanoate)] (PHBH) is preferred, and the copolymer produced by a microorganism is more preferred. Further, in addition to polyglycolic acid, polylactic acid, poly 3-hydroxybutyric acid, poly 4-hydroxybutyric acid, poly 4-hydroxyvaleric acid, poly 3-hydroxyhexanoic acid or polycaprolactone, at least one aliphatic polyester such as polyethylene adipate, polyethylene succinate, polybutylene adipate or polybutylene succinate, or a copolymer thereof can be added if necessary, as a polymer including an aliphatic polycarboxylic acid and an aliphatic polyhydric alcohol as a main constituent.

Herein, the term biodegradable poly[(3-hydroxybutyrate)-co-(3-hydroxyhexanoate)] is used as a generic name of copolymers having 3-hydroxybutyrate and 3-hydroxyhexanoate as a principal component. The copolymer is acceptable as long as 3-hydroxybutyrate and 3-hydroxyhexanoate are included as a principal component, and may also include any monomer component (recurring unit) other than these principal components. Further, the polymerization process for obtaining the aforementioned copolymer is not particularly limited, and any copolymerization process such as random copolymerization, alternating copolymerization, block copolymerization or the like may be employed.

The constituent ratio of the recurring units in the biodegradable poly[(3-hydroxybutyrate)-co-(3-hydroxyhexanoate)] used in the present invention preferably falls within the range of from 92/8 to 80/20 (mol/mol), and more preferably within the range of from 90/10 to 82/18 (mol/mol), in terms of (3-hydroxybutyrate) unit/(3-hydroxyhexanoate) unit. In the following description, with respect to the constituent ratio of the recurring units in poly[(3-hydroxybutyrate)-co-(3-hydroxyhexanoate)], the constituent ratio of 3-hydroxyhexanoate may be abbreviated as 3HH constituting proportion.

In general, as the 3HH constituting proportion is higher, the crystallinity is lowered, and more flexible polymer characteristic of PHBH tends to be exhibited. When 3HB/3HH is grater than 92/8, and thus the proportion of 3HB is greater, the crystallinity is increased, whereby the resin becomes brittle, and flexibility of PHBH may be deficient. Moreover, when 3HB/3HH in PHBH is less than 80/20, and thus the proportion of 3HB is lower, the crystallinity is lowered, accompanied by tendency of lowering of the crystal melting temperature, whereby the sheet may not be suited for applications in which heat resistance is required.

The weight average molecular weight of the biodegradable (3-hydroxyalkanoate) copolymer of the present invention is preferably 300,000 to 3,000,000, more preferably 400,000 to 2,500,000, and still more preferably 500,000 to 2,000,000 in light of the impact resistance and tensile characteristics. When the weight average molecular weight of the (3-hydroxyalkanoate) copolymer is less than 300,000, mechanical physical properties may be inferior, while when the weight average molecular weight exceeds 3,000,000, the molding may be difficult. The method of measuring the weight average molecular weight of the biodegradable (3-hydroxyalkanoate) copolymer is not particularly limited, but by way of example, the molecular weight of the biodegradable (3-hydroxyalkanoate) copolymer of the present invention can be determined as a molecular weight in terms of the polystyrene equivalent by measuring a GPC system manufactured by Waters Corporation equipped with a column Shodex K-804 (polystyrene gel) manufactured by Showa Denko K. K., using chloroform as a mobile phase.

PHBH for use in the present invention may be obtained by any method among methods of producing from a microorganism, and chemical synthetic methods, which is not particularly limited. Among all, PHBH produced from a microorganism is preferred in light of availability of PHBH by culturing a microorganism using a fat or oil as a source, as well as simple process and low cost as compared with a chemical synthetic method. In addition, PHBH produced from a microorganism is preferred in that it exhibits a broader molecular weight distribution as compared with PHBH obtained by a chemical synthetic method, and 3HB and 3HH are polymerized in a moderately nonuniform manner. Furthermore, PHBH obtained by a chemical synthetic method is not suitable because it can involve deteriorated physical properties due to residual unreacted monomer components and used polymerization initiator, and remaining emulsifying agent in the case of emulsion polymerization, and the like in PHBH.

The microorganism for producing the PHBH is not particularly limited as long as it is a microorganism which accumulates PHBH in the cells. Examples of such a microorganism include bacteria belonging to genus Alcaligenes such as A. lipolytica, A. eutrophus and A. latus, genus Pseudomonas, genus Bacillus, genus Azotobacter, genus Nocardia, and genus Aeromonas, and the like. Among them, particularly strains of Aeromonas caviae (genus Aeromonas), and further, Alcaligenes eutrophus AC32 (FERM BP-6038) (J. Bacteriol., 179, p. 4821-4830 (1997)) in which a gene of a PHA synthetic enzyme was introduced, and the like are more preferred in light of efficient production of PHBH. For the production, the microorganism bodies may be used in which this PHBH was accumulated in the body through culturing these microorganisms under appropriate conditions.

The biodegradable resin sheet referred to herein means a thin continuous piece having a great ratio of length to thickness, and a great ratio of width to thickness, which may include sheets and films. Although there is no clear definition of the upper limit of the thickness, the upper limit preferred as a sheet is equal to or less than 2 mm, and more preferably equal to or less than 1 mm. The lower limit is not particularly limited as long as it has a thickness which can be produced in the form of a sheet (film).

The crystallinity of the biodegradable resin sheet in the present invention is a value determined based on area ratio of the harrow area derived from non-crystalline portion and the peak area derived from crystalline portion in an X-ray diffraction diagram, with a Vonk method (C. G. Vonk, J. Appl. Crystallogr., 6,148 (1973)) according to wide angle X-ray diffraction.

According to the sheet constituted with PHA of the present invention, the rate of change of the tensile elongation with respect to the change in crystallinity from day 1 to day 30 after manufacturing the sheet is equal to or less than 20, preferably equal to or less than 10, and more preferably equal to or less than 5. Furthermore, the tensile elongation (%) of the sheet constituted with PHA of the present invention is equal to or greater than 100(%), and preferably equal to or greater than 150(%) after a lapse of 60 days following manufacture of the sheet.

Additionally, the sheet constituted with PHA of the present invention has a crystallinity after a lapse of 30 days following manufacture of the sheet of preferably equal to or less than 45%, and more preferably equal to or less than 40%. When the crystallinity after a lapse of 30 days following manufacture is beyond 45%, the rate of change of the tensile elongation with respect to the change in crystallinity becomes so great that the tensile elongation is lowered. Also, the lower limit of the crystallinity is equal to or more than 20%. When the crystallinity is lower than this lower limit, heat resistance may be deteriorated. Particularly preferred range is equal to or more than 30%, and is equal to or less than 40%. Most preferred range is equal to or more than 31%, and is equal to or less than 37%.

Moreover, the sheet constituted with PHA of the present invention preferably has a distance of crystal period after a lapse of 1 day following manufacture of the sheet being equal to or greater than 6.5 nm. More preferably, the distance is equal to or greater than 7.0 nm. The distance falling within this range is believed to be preferred because amorphous region present in the crystal period is enlarged through having the distance of the crystal period of equal to or greater than 6.5 nm, and thus there exists the amorphous region even if the crystallinity is elevated whereby influence thereof is minimized, and thus influence on the tensile elongation and glass transition temperature can be minimized. Particularly preferred range is equal to or more than 7.0 nm, and is equal to or less than 9.0 nm. Most preferred range is equal to or more than 7.0 nm, and is equal to or less than 8.5 nm.

Further, according to the sheet constituted with PHA of the present invention, the change of the glass transition temperature from day 1 to day 30 after manufacturing the sheet represented by the formula (2): (glass transition temperature (° C.) after a lapse of 30 days following manufacture)−(glass transition temperature (° C.) after a lapse of 1 day following manufacture) is preferably equal to or less than 2° C. More preferably, the change is equal to or less than 1° C. Such less time dependent change of the glass transition temperature can provide the sheet of the present invention with more stable flexibility.

Manufacturing Method of Sheet Constituted with PHA

The method of manufacturing the biodegradable resin sheet according to the present invention is not particularly limited, and can be manufactured arbitrarily as needed. For example, a melt extrusion process used in the case of sheet formation of frequently used thermoplastic plastics such as polyethylene, polypropylene, polystyrene and the like can be exemplified, in which a sheet or a film is formed with an extruder equipped with at the tip a T die having a large width with narrow slit intervals (T die process), or a ring die having ring intervals (inflation process), or the like as needed. Furthermore, sheet formation by a calender process which has been often used in sheet formation of a vinyl chloride resin or a polyethylene oxide resin may be exemplified. The calender molding is a process for producing a sheet by rolling a resin between rolls, and the roll type can be selected as needed depending on the arrangement of the rolls which include linear three-roll type, reverse L type, Z type and the like.

Moreover, an emulsion process and a casting process using a solvent, as well as a co-extrusion process and a lamination process by lamination with other resin may be exemplified, and such a method may be used as needed. Furthermore, stretch orientation can be effected by drawing in both or either one of length and breadth directions, and any processing method may be employed which is carried out in formation of frequently used plastic sheets or films.

Although the thickness of the sheet of the present invention can be arbitrarily adjusted if necessary, the thickness can be also adjusted by laminating a flexible resin layer or the like in combination for imparting flexibility.

In the resin sheet of the present invention can be included a colorant such as a pigment or a dye, inorganic and organic particles, a glass fiber, a natural fiber such as kenaf and cellulose, a filler such as a whisker and mica, a stabilizer such as an antioxidant and an ultraviolet ray absorbing agent, a plasticizer, a lubricant, a release agent, a water repellent agent, an antimicrobial agent, and other secondary additives as needed.

The resin sheet of the present invention can be used as paper, film, sheet, vessel, bag or the like per se, or alternatively, it may be used as a molded article having improved physical properties by combining with paper, film, sheet, vessel, bag or the like constituted with a variety of material other than this resin sheet. A variety of molded articles obtained in such a manner can be suitably used in fields such as agriculture, fishery, forestry, horticulture, medicine, sanitary goods, food industry, clothing, nonclothing, packaging, automobile, building material, and others.

### EXAMPLES

Hereinafter, the present invention will be explained in more detail by way of Examples, but the present invention is not anyhow limited to these Examples.

### Examples 1 to 3

### Comparative Examples 1 to 2

### Preparation of PHBH

Used PHBH was produced using Alcaligenes eutrophus AC32 (J. Bacteriol., 179, p. 4821 (1997)), which had been prepared by introducing a PHA synthetic enzyme gene derived from Aeromonas caviae into Alcaligenes eutrophus, as a microorganism, through arbitrarily adjusting the raw material and culture conditions. The PHBH used had a 3HH constituting proportion of 5, 7, 10, 12, or 18 mol %, and Mw (weight average molecular weight) of 640,000, 1,000,000, 310,000, 760,000, and 570,000, respectively.

### Production of Film

Five kinds of PHBH having different 3HH constituting proportions were casted from a chloroform solution, and the solvent was evaporated at a room temperature for one day, followed by additional drying at 40° C. for one day. The film sample was then used in determination as a sample on day 1. Thereafter, it was preserved at a room temperature in a vacuum dryer, and determined on day 7, day 30, and day 60.

### Tensile Test

A test piece was excised from the aforementioned casted film, and thereon was carried out a tensile test with a sample thickness of 0.1 mm, an interguage distance of 22.25 mm, and at a tensile speed of 20 mm/min, and at a room temperature using a tensile tester (Shimadzu Corporation, type: EZ Test). Accordingly, tensile elongation at break was determined in terms of an average value with the number n being 5.

### Measurement of Crystallinity Degree

Using an X-ray diffractometer (Rigaku Corporation, Rotaflex RU-200), wide angle X-ray diffraction was measured using a Ni-filtered CuKa ray (λ=0.154 nm, 40 kV, 200 mA) as an X-ray source, with an angle area of 2θ: 5 to 60°, at a scanning speed of 1.0°/min. From the measurement results of thus resulting wide angle X-ray diffraction, crystallinity was determined by calculating according to a Vonk method.

### Determination of Distance of Crystal Period

Using an apparatus similar to that for the wide angle X-ray diffraction, small angle X-ray diffraction was determined with an angle area of 2θ: 0.1 to 3.4°, a step of 0.004°, and with each step of time period for 20 seconds. From the measurement results of the obtained small angle X-ray diffraction, the distance of crystal period was determined by calculation.

Rate of Change of Tensile Elongation Degree with Respect to Change in Crystallinity Degree

Based on the crystallinity and tensile elongation on day 1, and crystallinity and tensile elongation on day 30 determined as described above, the rate of change of the tensile elongation with respect to the change in crystallinity (%) from day 1 to day 30 after manufacturing the sheet represented by the formula (1): {[(tensile elongation (%) after a lapse of 1 day following manufacture)−(tensile elongation (%) after a lapse of 30 days following manufacture)]/[(crystallinity (%) after a lapse of 30 days following manufacture)−(crystallinity (%) after a lapse of 1 day following manufacture)]} was determined.

### Determination of Glass Transition Temperature

The glass transition temperature was determined with DSC-200 type Differential Scanning Colorimeter produced by Seiko Instruments Inc. by weighing 10 mg of the sample in a cell, and elevating the temperature from −100° C. to 190° C. at the elevating rate of 10° C. /min under the nitrogen gas.

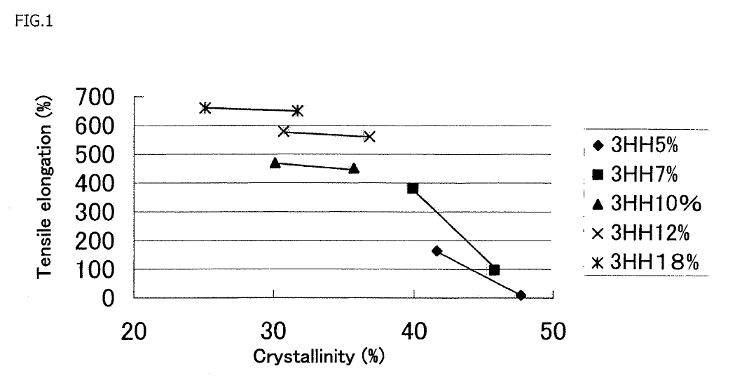

The results obtained in the tests described above are summarized in Table 1. In addition, a graph generated by plotting correlation between crystallinity and tensile elongation on day 1 and day 30 is shown in FIG. 1.

TABLE 1

| | | Compar. Example | | Example | | |
|---|---|---|---|---|---|---|
| | | 1 | 2 | 1 | 2 | 3 |
| PHBH | | 3HB/3HH | 3HB/3HH | 3HB/3HH | 3HB/3HH | 3HB/3HH |
| 3HB/3HH | | 95/5 | 93/7 | 90/10 | 88/12 | 82/18 |
| mol % ratio | | | | | | |
| Tensile | day 1 | 164 | 381 | 470 | 580 | 661 |
| elongation | day 7 | 13 | 195 | 456 | 573 | 650 |
| (%) | day 30 | 9 | 97 | 452 | 561 | 651 |
| | day 60 | 7 | 73 | 388 | 549 | 538 |
| Crystallinity | day 1 | 41.6 | 39.9 | 30.1 | 30.7 | 25.1 |
| (%) | day 7 | 44.5 | 41.2 | 34.7 | 32.7 | 27.4 |
| | day 30 | 47.7 | 45.8 | 35.7 | 36.8 | 31.7 |
| | day 60 | 47.9 | 46.3 | 35.9 | 37.7 | 29.3 |
| Glass | day 1 | −5.3 | −5.0 | −6.4 | −6.9 | −8.1 |
| Transition | day 7 | −4.3 | −3.4 | −5.9 | −6.2 | −8.0 |
| Temperature | day 30 | 1.2 | −1.4 | −6.2 | −6.2 | −8.0 |
| (° C.) | day 60 | — | N.D. | −5.8 | −6.3 | −7.9 |
| Distance of crystal | day 1 | 6.4 | | 7.1 | 8.0 | |
| period (nm) | | | | | | |

| | | | | | |
|---|---|---|---|---|---|
| Change in tensile elongation | 155 | 284 | 18 | 19 | 10 |
| from day 1 to day 30 | | | | | |
| Change on crystallinity | 6.1 | 5.9 | 5.6 | 6.1 | 6.6 |
| from day 1 to day 30 | | | | | |
| Rate of change: | 25.4 | 48.1 | 3.2 | 3.1 | 1.5 |
| change in tensile elongation/ | | | | | |
| change in crystallinity | | | | | |
| Change in glass transition | 6.5 | 3.6 | 0.2 | 0.7 | 0.1 |
| temperature from day 1 to day 30 | | | | | |

Examples 1 to 3, which exhibited a rate of change of the tensile elongation with respect to the change in crystallinity (%) from day 1 to day 30 being equal to or less than 20, and having a crystallinity after a lapse of 30 days being equal to or less than 45%, and having the change of the glass transition temperature being equal to or less than 2° C., exhibited tensile elongation as high as 100% or greater even on day 60. Accordingly, it was revealed that a film which was accompanied by less alteration after a lapse of a long period of time, and had stable flexibility was obtained. To the contrary, Comparative Examples 1 to 2, which exhibited a rate of change of the tensile elongation with respect to the change in crystallinity (%) from day 1 to day 30 being equal to or greater than 20, and having a crystallinity after a lapse of 30 days beyond 45%, and having the change of the glass transition temperature beyond 2° C., exhibited tensile elongation on day 60 as low as 7 to 73%. Accordingly, it was revealed that a great time dependent alteration for a long period of time was shown, suggesting that merely a film which was accompanied by significant reduction in tensile elongation and flexibility could be obtained.

1. A biodegradable resin sheet which comprises a biodegradable (3-hydroxyalkanoate) copolymer,
wherein the rate of change of the tensile elongation with respect to the change in crystallinity (%) from day 1 to day 30 after manufacturing the sheet represented by the formula (1): {[(tensile elongation (%) after a lapse of 1 day following manufacture)−(tensile elongation (%) after a lapse of 30 days following manufacture)]/[(crystallinity (%) after a lapse of 30 days following manufacture)−(crystallinity (%) after a lapse of 1 day following manufacture)]} is equal to or less than 20, and the tensile elongation after a lapse of 60 days following manufacture of the sheet is equal to or greater than 100(%).

2. The sheet according to claim 1 wherein the rate of change of the tensile elongation represented by the formula (1) is equal to or less than 10.

3. The sheet according to claim 1 wherein the tensile elongation after a lapse of 60 days following manufacture of the sheet is equal to or greater than 150(%).

4. The sheet according to claim 1 wherein the crystallinity after a lapse of 30 days following manufacture of the sheet is equal to or less than 45%.

5. The sheet according to claim 1 wherein the distance of the crystal period after a lapse of 1 day following manufacture of the sheet is equal to or greater than 6.5 nm.

6. The sheet according to claim 1 wherein the change of the glass transition temperature from day 1 to day 30 after manufacturing the sheet represented by the formula (2): (glass transition temperature (° C.) after a lapse of 30 days following manufacture)−(glass transition temperature (° C.) after a lapse of 1 day following manufacture) is equal to or less than 2° C.

7. The sheet according to claim 1 wherein the biodegradable (3-hydroxyalkanoate) copolymer is poly[(3-hydroxybutyrate)-co-(3-hydroxyhexanoate)] having a (3-hydroxybutyrate) recurring unit and a (3-hydroxyhexanoate) recurring unit.

8. The sheet according to claim 7 wherein the constituent ratio of the recurring units in the poly[(3-hydroxybutyrate)-co-(3-hydroxyhexanoate)] falls within the range of from 92/8 to 80/20 (mol/mol) in terms of (3-hydroxybutyrate) unit/(3-hydroxyhexanoate) unit.
